(19) United States
(12) Patent Application Publication
(10) Pub. No.: US 2014/0004770 A1
(43) Pub. Date: Jan. 2, 2014

(54) Pollen Feeder

(71) Applicant: John Henry Nenninger, Festus, MO (US)

(72) Inventor: John Henry Nenninger, Festus, MO (US)

(21) Appl. No.: 13/539,277

(22) Filed: Jun. 29, 2012

(51) Int. Cl. A01K 47/06

(52) U.S. Cl. 449/19

(57) ABSTRACT

The pollen feeder is a device made out of plastic that is attached to a beehive body box of standard opening. The beekeeper will unscrew the cap placing pollen or pollen substitute into the silo. The pollen will be suspended above the feeding area by number eight screen. The pollen feeder is light weight and is easily held in place by the weight of the hive body box. The pollen feeder permits the beekeeper to measure the amount of pollen used by a particular colony. The pollen feeder will help the beekeeper to deter the development of small hive beetles.

### CROSS-REFERENCE TO RELATED APPLICATIONS

### US Patent Documents

“Not Applicable”

### Publication Number(s)

“Not Applicable”

### STATEMENT REGARDING FEDERALLY SPONSORED

“Not Applicable”

### BACKGROUND OF THE INVENTION

The small hive beetle, “Aethina tumida,” is a pest that was introduced to the United States in the 1980s. When a bee colony becomes weak, the small hive beetle will destroy the colony. The small hive beetle lays its eggs in clusters in cracks and crevices and especially in pollen patties. The pollen patties are a substance made by man to supplement the bee's need for natural pollen. It's been said that if you wish to raise small hive beetles feed pollen patties to your bees. It has been known for quite some time that dry pollen will prevent small hive beetles. The current method of feeding dry pollen is by providing pollen in open containers or semi-closed containers in a bee yard. Although this is the usual method, it permits other insects access to pollen, it permits weather to contaminate the pollen, and it encourages healthy bees to come in contact with diseased bees. Currently there are no pollen feeding devices that attach to bee boxes.

### BRIEF SUMMARY OF THE INVENTION

The Pollen Feeder is made out of plastic. It has three components, the base, the silo, and the cap. The base fits into the standard opening of a beehive held in place by the weight of the hive body box. The silo has female threads that are screwed on to the base male threads. This attachment method helps to prevent water entering into the base of the pollen feeder. The cap has female threads that screw on to the silo male threads, this will prevent water from entering into the silo. The bees will enter through the opening retrieving the pollen or pollen substitute. The pollen feeder will reduce the transfer of diseases and pests between bee colonies and help to control small hive beetles.

### BRIEF DESCRIPTION OF THE DRAWING

FIG. 1 drawing is a cutaway view of the base, the silo, and cap. It shows the number eight wire mesh that will hold the pollen in place. The drawing also shows the space where the bees will enter and retrieve the pollen.

FIG. 2 is a pictorial view looking from right to left. The pictorial view shows the cap, the silo, and base all screwed together. It shows the portion of the base that will be inserted into a standard hive body opening.

### DETAILED DESCRIPTION OF THE INVENTION

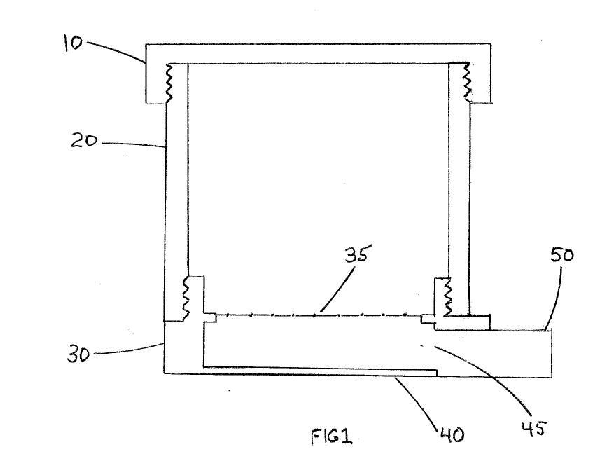

FIG. 1 is a cutaway view of the assembled pollen feeder. The cap label 10 screws to the top of the silo label 20. The silo label 20 stores the pollen and screws on to the base label 30. The base label 30 has number eight screen label 35 which supports the pollen above the feeding area. The feeding area is the space between label 35 and label 40. Label 40 is the recessed bottom of the pollen feeder. Label 40 is recessed so that if any water leaks between the pollen feeder and the hive body box the water will drain down the bottom board of the hive. Bees enter the pollen feeder through the area label 45. The portions of the base Label 50 will be inserted to a standard opening of a hive body box.

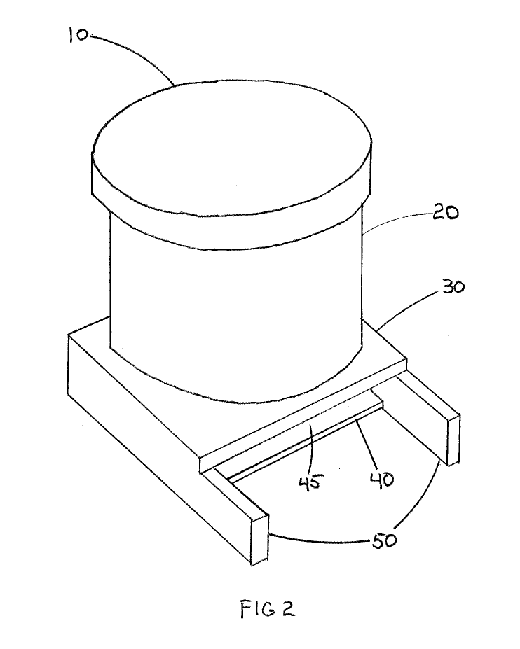

FIG. 2 is a pictorial view showing the assembled pollen feeder. The pollen feeder consists of three parts, the cap label 10, the silo label 20, and a base label 30. The bottom of the base is label 40. The bottom is recessed so that if water enters along the edge of the hive body box and the edge of the pollen feeder, the water will drain to the ground. Label 45 is the space where the bees enter into the pollen feeder. The portions of the base Label 50 will be inserted to a standard opening of a hive body box.

1. This invention will permit bees of a single colony direct access to their individual pollen supplies.

2. This invention will eliminate contamination of pollen that is stored in the open.

3. This invention will prevent small hive beetles from developing. Small hive beetles lay their eggs in moist pollen patties.

4. This invention will eliminate pests and disease transfer between bee colonies that occur in open air feeders.
